(19) United States
(12) Patent Application Publication
(10) Pub. No.: US 2008/0223240 A1
(43) Pub. Date: Sep. 18, 2008

(54) Method of Printing

(75) Inventors: Paul R. Drury, Hertfordshire (GB); Robert A. Harvey, Cambridge (GB)

Correspondence Address: MARSHALL, GERSTEIN & BORUN LLP, 233 S. WACKER DRIVE, SUITE 6300, SEARS TOWER, CHICAGO, IL, 60606, US

(73) Assignee: XAAR TECHNOLOGY LIMITED, Cambridgeshire (GB)

(21) Appl. No.: 12/065,574

(22) PCT Filed: Sep. 4, 2006
(86) PCT No.: PCT/GB2006/003264

§ 371 Date: Mar. 19, 2008

(30) Foreign Application Priority Data
Sep. 2, 2005 (GB) GB 0517931.2

(51) Int. Cl. B41F 3/34

(52) U.S. Cl. 101/492

(57) ABSTRACT

A method of offset printing wherein a layer of varnish or similar coating material is deposited onto a print drum and an ink image pattern layer is printed upon the varnish layer using a technique such as inkjet printing; the print drum transfers the ink layer onto a print substrate with a portion of the varnish layer thereupon, thus acting as a covering layer for the printed image.

This invention relates to methods of printing and in particular to offset printing.

In conventional printing methods ink is deposited directly upon a print substrate. The problems inherent in such methods are well known and include bleeding, strikethrough and runoff of the ink. To avoid such problems requires a careful, and thus limiting, choice of ink and substrate. This is particularly this case with inkjet printing where the ink is deposited in droplets on the substrate. The substrate is required to be porous enough to absorb the ink to avoid runoff, but not so porous as to cause strikethrough.

With very porous substrates it has been found that ink penetrates up to 10-15 μm into the surface of the paper following conventional printing. As a result, the pigment particles are fairly disperse normal to the substrate. It is well known that the impression of colour is caused by photons reflected by the surface of the substrate interacting with the pigment particles. Such photons have a mean free path of around 2 μm after reflection by the substrate. Thus, with pigment penetrating up to 15 μm into the substrate, the intensity of coloured light that reaches the viewer is very low. This causes the colours printed upon such a substrate to appear dull.

In offset printing, ink is deposited onto a transfer medium, commonly a metal drum, before being deposited onto a substrate. In a typical method of offset printing, a metal drum has the pattern of the desired printed image etched into it, creating an oleophilic layer in the desired print pattern. The circumference of the drum is such that it is equal to the image height. Water is applied over the whole surface, but adheres only to the negative of the print pattern. Ink is transferred onto the drum, adhering to the oleophilic layer, and being repelled by the water layer due to the immiscibility of the ink and water. The metal drum is rolled against a rubber drum, to which the ink adheres, and the rubber drum rolls the ink layer over the intended print substrate, thus transferring the image. Continuous rolling of the rubber drum onto a substrate produces a series of repetitions of the same printed image on the substrate. Typically a single colour ink will be used for a single roller, and a series of rollers is employed, one for each different colour of ink required. Usually four rollers are used—Cyan, Yellow, Magenta and Black. For a high quality reproductive of the print pattern, these rollers must be in exact registration with each other.

An advantage of this type of offset printing is that the ink is physically pressed onto the substrate by the rolling of the drum. Inks used in offset printing are of much higher viscosity in order to adhere to the substrate, creating a high concentration of pigment particles in a 2 μm layer. This affords a high quality print finish even with a relatively poor quality substrate, whereas droplet deposition of ink onto such poor quality substrates would result in problems such as bleeding, strikethrough or runoff. The high viscosity of such inks prevents them from being used with conventional droplet deposition printing. A further advantage of offset printing is that the process can be operated at high speed continuously.

Since a drum is only capable of printing a single image, runs of approximately 10,000 are usually required to justify this method of printing.

Computer to plate technology allows an image pattern created on a computer to be directly transferred to a print plate, commonly fabricated in polyester rather than metal. Whilst this allows for faster creation of print plates, thus making lower volume productions possible, the setup costs may still be considerable at $2,000 upward to $200,000. Even with this technology a different print plate is required for each image and hence the high setup costs act as a barrier to the feasibility of low-volume production.

Methods are known in the art for creating an oleophilic pattern directly on the print drum by a variety of methods. DE3821268 proposes a method where the drum is wetted with liquid in a thin layer, which is subsequently irradiated dropwise to form a series of dry drops corresponding to a raster of the printed page. Colour is then applied to the drum and the image transferred to the paper through an offset roller.

EP0522804 proposes a system with an apparatus for applying oleophilic materials in image-formatted patterns on a layer of hydrophilic material on the master-image printing cylinder to form a printing structure having separate hydrophilic and oleophilic areas of the formate to be printed. A mechanism is provided for removing the printing structure so that a new printing structure can be formed on the master-image printing cylinder.

Ink jet printing is a digital technology which allows different images to printed on successive sheets and the technology has found wide application in office, packaging and many other markets. In general, however, ink jet is a contact-less technology and as such cannot match the quality of offset or other contact print processes where ink is forced under pressure into contact with a substrate.

Ink jet offset printing arrangements have been proposed in an attempt to combine the quality advantages of offset with the freedom to switch from image to image (if necessary, between sheets of media) that is inherent in digital printing. In practice, however, the ability to switch from image to image is limited by an effect known as ghosting where residue ink from the previous image remains on the drum or plate and contaminates the current image. This problem can be overcome by cleaning between images, but this of course negates the advantage that is sought.

In one aspect, the present invention provides a method of printing comprising depositing a layer of fluid onto a print plate to form a cover layer; depositing an ink layer onto said cover layer; transferring said ink layer from said print plate to a substrate, wherein a portion of said cover layer is also transferred with said ink layer onto said substrate.

By transferring ink to the substrate in this way, such that the cover layer separates, no residual ink is left on the print plate. Thus, the present invention advantageously allows a new image or pattern to be applied to the print plate, without the risk of contamination or ‘ghosting’ from the previous image.

Preferably the print plate is a rotating drum, and preferably the ink layer is deposited by ink jet printing. In this way a new image can be deposited onto the drum each revolution, and printed onto the substrate in a continuous fashion. The present invention therefore affords improved quality images to be produced on a substrate for which direct printing would result in low quality, thus extending the range of substrates that may be used.

The cover layer is preferably transparent but may be clear tinted or coloured. The cover layer may be formed by deposition of a varnish or other suitable clear polymer resin. The cover layer is desirably of similar viscosity to the ink layer, and it may be further desirable for the cover layer to be immiscible with the ink layer. In an alternative arrangement, the cover layer has a similar composition to the ink, lacking only the pigment.

The cover layer may be applied to the whole printable surface of the print plate, for example using a doctor blade and reservoir arrangement. Alternatively the cover layer may be printed onto the print plate. Printing of the cover layer may be onto the whole surface, or onto only a selected portion.

The cover layer may comprise a wide variety of substances, the most trivial of which is varnish, being essentially ink without pigment. Such a layer requires its own printing unit on press. Varnish comes in gloss, dull, and satin (in-between dull and gloss), and can be tinted by adding pigment to the varnish. With the use of more than one varnish printing unit certain areas of the substrate may be dull-varnished, others gloss varnished and some without varnish. This contrast can give emphasis to certain areas and/or give the impression of depth.

Also known in the art is UV Coating—a clear liquid spread over the paper like ink and then cured instantly with ultraviolet light. It can be a gloss or dull coating, and can be used as a spot covering to accent a particular image on the sheet or as an overall (flood) coating. Gloss UV coating provides a particularly striking sheen which is extremely desirable in the print industry. UV coating also gives more protection and sheen than either varnish or aqueous coating. Since it is cured with light and not heat no solvents enter the atmosphere, although it is more difficult to recycle than the other coatings.

A further cover layer material is conventional aqueous coating. This is more environmentally friendly than UV coating as it is water based, has better hold-out than varnish (it does not seep into the sheet) and does not crack or scuff easily. Aqueous does, however, cost roughly twice as much as conventional varnish. Since it is applied by an aqueous coating tower, one can only lay down a flood aqueous coating, not a localized “spot” aqueous coating. Aqueous coating is available in gloss, dull, and satin finishes.

The portion of the cover layer transferred to the substrate will undergo a phase change; it may be allowed to dry, or may be cured eg by UV curing.

The portion of the cover layer transferred to the substrate will remain on the substrate with the ink layer, becoming part of the formed image. Examples of the invention can take advantage of the decorative and other benefits of varnish and similar cover layers, which are well understood. Depending upon the desired effect, gloss, silk or matt varnishes can be employed.

WO 00/30856 discloses printing a wet varnish undercoat on a substrate, printing ink upon the undercoat and subsequently curing both layers. It is known from this document that this significantly reduces the variability in droplet behaviour after printing. Thus, advantageously, the cover layer and the ink layer may be cured simultaneously in the present invention. It is also known from this document to vary the thickness of the varnish layer inversely with the thickness of the ink layer, thus producing a constant total thickness. This technique may be applied advantageously to the formation of the cover layer in the present invention, thus allowing the total thickness of the layer of ink and varnish transferred to remain constant.

It is known that, in order to jet, the ink when in an ink jet print head must be at a relatively low viscosity. It is also known that to obtain good print quality, the ink when transferred from the drum to the substrate (typically under pressure applied by a counter-roller) must be at relatively high viscosity. The desired change in viscosity (as measured in Pascal seconds) is preferably greater than 100 times, more preferably greater than 500 times, and most prefereably greater than 1000 times.

The ink may advantageously be designed in order that the viscosity changes rapidly with respect to temperature to establish a compromise between jetting performance and the resultant print quality on the substrate. The necessary high rate of change of viscosity with temperature may be achieved by several methods.

It is known that block copolymers may be designed to exhibit such a sharp change in viscosity over a desired temperature range. An ink utilising a fluid comprising such block copolymers would be extremely desirable for this method of printing.

It is also known to use UV curable inks with droplet deposition printing. Such inks may be partially cured after deposition on the printing drum to afford the desired change in viscosity before pressing of the ink onto the substrate.

It is further known to use inks comprising waxes, hot-melt inks and phase change inks. These may be engineered to give the desired change in viscosity over a suitable temperature range. Hot-melt and phase change inks are particularly prone to damage by abrasion, hence the added protection of a cover layer will be particularly advantageous.

Such ink may allow an ink layer thickness on non-coated paper of around 2 microns to be achieved, as against the typical 10 to 15 micron thickness typically achieved when inkjet printing onto non-coated papers. This will result in less strike-through and less dot spread.

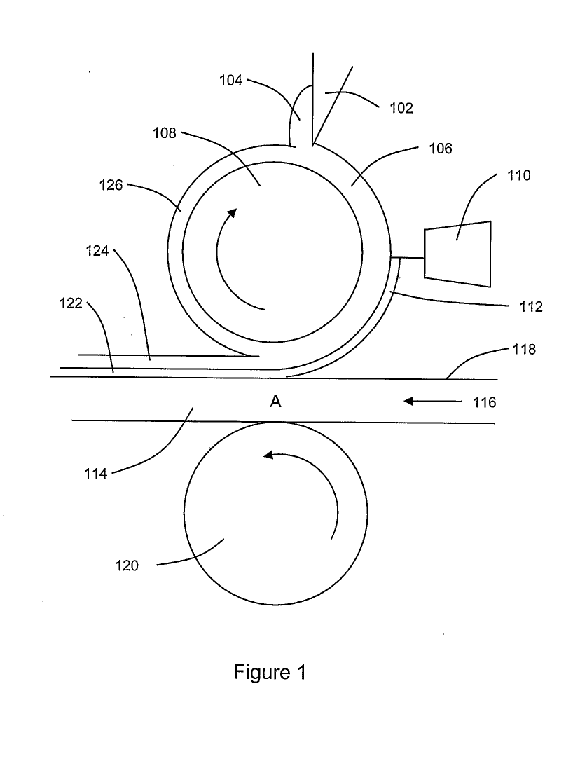

The invention will now be described by way of example with reference to FIG. 1 which illustrates a printing operation in accordance with the present invention.

Referring to FIG. 1, a doctor blade 102 having a reservoir 104 deposits a layer of varnish 106 onto a rotating drum 108. The thickness of the deposited varnish layer 106 is controlled by the position of the doctor blade. An inkjet print head 110 is arranged to print onto the varnish layer 106 forming an ink layer on top of the varnish, as shown schematically by layer 112.

A substrate 114 for example a continuous roll of paper, travels in a substrate direction as shown by arrow 116 comes into tangential contact with rotating drum 108 in a contact zone indicated at A, and ink layer 112 is pressed against the top surface 118 of the substrate. A backing drum 120 rotating in the opposite sense to drum 108 may be provided to improve the contact.

The ink layer 112 adheres to the substrate and is separated from drum 108 as it rotates away from the contact zone. As the drum rotates away, the varnish layer divides. A portion of the varnish layer 106 is transferred with the ink to the substrate, and a portion remains on the drum 108. This results in a printed substrate having a layer of ink 122 underneath a thin varnish coating 124. The varnish 126 remaining on the drum continues round with the drum to reservoir 104, where the thickness of the varnish layer is restored by doctor blade 102.

The portion of the varnish layer that remains on the drum may be extremely small, and in some applications may be zero.

Since the coating 124 is clear the ink on the printed substrate can be viewed clearly. In some applications a glossy finish is desirable, and the clear layer can improve the colour density or brightness of the printed image. Although the varnish layer is applied with a doctor blade in the embodiment of FIG. 1, the varnish layer could equally be printed onto the drum. Such printing could provide a varnish layer across the whole surface of the drum, or onto selected areas only. Advantageously a varnish layer is printed only onto the active image areas of the drum which are to receive ink. If varnish is printed onto the drum in this way, a scraper or other cleaning means is preferably provided to remove the residual layer 126, prior to the application of a new layer.

1. A method of printing comprising:
depositing a layer of fluid onto a print plate to form a cover layer;
depositing an ink layer onto said cover layer; and, transferring said ink layer from said print plate to a substrate, wherein a portion of said cover layer is also transferred with said ink layer onto said substrate.

2. A method according to claim 1, wherein said fluid is a clear polymer resin.

3. A method according to claim 1, comprising forming the cover layer over substantially the whole of the printable area of the print plate.

4. A method according to claim 1, comprising forming the cover layer selectively over a portion of the print plate.

5. A method according to claim 1, comprising at least partially UV curing the ink layer or cover layer before transferring the ink layer and said portion of the cover layer to the substrate.

6. A method according to claim 1, comprising UV curing the portion of the cover layer transferred onto said substrate.

7. A method according to claim 1, wherein the print plate is a rotatable drum.

8. A method according to claim 1, wherein one of the ink layer and cover layer comprises a block copolymer.

9. A method according to claim 1 wherein the ink is a hot-melt ink.

10. A method according to claim 1 wherein one of the ink or the cover layer undergoes a phase change after deposition and before transfer to the substrate.

11. A method according to claim 1 wherein the viscosity of the ink changes by a factor greater than 100 times from immediately before deposition to immediately before transfer to the substrate.

12. A method according to claim 10 wherein the viscosity of the ink changes by a factor greater than 500 times from immediately before deposition to immediately before transfer to the substrate.

13. A method according to claim 11 wherein the viscosity of the ink changes by a factor greater than 1000 times from immediately before deposition to immediately before transfer to the substrate.
